(19) United States
(12) Patent Application Publication
(10) Pub. No.: US 2023/0394416 A1
(43) Pub. Date: Dec. 7, 2023

(54) Systems and Methods for Waste Management with Service Confirmation

(71) Applicant: RUBICON TECHNOLOGIES, LLC, Lexington, KY (US)

(72) Inventor: Philip RODONI, Decatur, GA (US)

(73) Assignee: RUBICON TECHNOLOGIES, LLC, Lexington, KY (US)

(21) Appl. No.: 17/805,635

(22) Filed: Jun. 6, 2022

(51) Int. Cl. G06Q 10/06; G06Q 50/26; H04W 4/029; H04W 4/40; G06V 20/56; G06V 10/25; G06V 10/82

(52) U.S. Cl. CPC G06Q 10/06395; G06Q 50/26; H04W 4/029; H04W 4/40; G06V 20/56; G06V 10/25; G06V 10/82

(57) ABSTRACT

A system is disclosed for managing waste services performed by a service vehicle. The system may have a locator mounted to the service vehicle and configured to generate a location signal, a sensor mounted at a waste opening of the service vehicle and configured to generate a receptacle signal, and a processor in communication with the locator and the receptacle sensor. The processor may be programmed to determine, based on the location signal, operation of the service vehicle in a service mode and, during operation in the service mode, automatically detect, based on the receptacle signal, existence of a waste receptacle at the waste opening. The processor may also be programmed to responsively generate an electronic output based on the detection.

### TECHNICAL FIELD

The present disclosure relates generally to a management system and, more particularly, to a waste collection management system having service confirmation.

### BACKGROUND

Service vehicles have been widely used in the waste industry to collect waste discarded from subscribing customers and to transport the collected waste to a disposal location. Waste service providers typically dispatch the service vehicles to customer properties according to a predetermined pickup schedule assigned to each vehicle. The pickup schedule for each service vehicle is often designed to provide waste services within a particular geographical area at a particular frequency (e.g., once per week). After completion of the waste services, the vehicle operator reports the completion of services to a back office, which updates the operator's schedule and an account record for the customer.

In some instances, it may be difficult to confirm that a scheduled service has been completed and/or completed in a manner desired by the customer (e.g., that particular receptacles were emptied, that the receptacles were emptied on a desired day and/or at a desired time, etc.). The most common method used to verify service completion is self-reporting by the vehicle operator, who may make a mistake in performing the pickup service, make a mistake in recording of the service, or otherwise introduce errors in reporting of the service. Not only can these methods be error-prone, but they can also be cumbersome, time consuming, and distracting for the vehicle operator.

The disclosed system is directed to overcoming one or more of the problems set forth above and/or other problems of the prior art.

### SUMMARY

According to one embodiment, the present disclosure is directed to systems for managing waste services performed by a service vehicle, comprising: a locator mounted to the service vehicle and configured to generate a location signal; a sensor mounted at a waste opening of the service vehicle and configured to generate a receptacle signal; and a processor in communication with the locator and the sensor and configured to: determine, based on the location signal, operation of the service vehicle in a service mode; detect, based on the receptacle signal, existence of a waste receptacle at the waste opening; and generate an electronic output based on the detection.

According to another embodiment, the present disclosure is directed to a method for managing waste services performed by a service vehicle, the method comprising: detecting a location of the service vehicle; determining, based on the location, operation of the service vehicle in a service mode; detecting existence of a waste receptacle at a waste opening of the service vehicle; and generating an electronic output based on the detection.

According to another embodiment, the present disclosure is directed to a non-transitory computer readable medium comprising program code, which when executed by one or more processors, is configured to cause the one or more processors to: detect a location of a service vehicle; determine, based on the location, operation of the service vehicle in a service mode; detect existence of a waste receptacle at a waste opening of the service vehicle; and responsively generating an electronic output based on the detection.

These illustrative embodiments are mentioned not to limit or define the disclosure, but to provide examples to aid understanding thereof. Additional embodiments and further descriptions are discussed in the Detailed Description.

### BRIEF DESCRIPTION OF THE DRAWINGS

FIG. 1 is an illustration of an example waste management environment according to one embodiment of the present disclosure;

FIG. 2 is a diagrammatic illustration of an example waste management system according to one embodiment of the present disclosure;

FIG. 3 is an illustration of an image that may be processed by the system of FIG. 2 according to one embodiment of the present disclosure;

FIG. 4 is a flow chart of an example method for operating a waste management system according to one embodiment of the present disclosure; and

FIG. 5 is another flow chart of an example method for operating a waste management system according to one embodiment of the present disclosure.

### DETAILED DESCRIPTION

An illustrative example of the present disclosure comprises a system for managing waste service performed by a service vehicle. The service vehicle includes multiple sensors configured to generate signals. One such sensor included on the vehicle is a locator configured to generate a location signal. Optical sensors, such as cameras, are located at different areas of the service vehicle. An optical sensor located at a waste opening of the service vehicle is configured to generate a receptacle signal when the sensor identifies a receptacle (e.g., a trash can, dumpster, or other waste receptacle at a customer location). A processor in communication with the sensors determines operations to perform based on the signals from the sensors. The processor is further configured to transmit information to a base station and generate output displayed to the driver of the service vehicle in a graphical user interface.

In one illustrative example, the service vehicle sets out on a route to collect waste from receptacles at several customer locations. As the service vehicle travels along the route, optical sensors on the service vehicle identify waste receptacles. By using the location signal generated by the locator, the system identifies the waste receptacle as being associated with a particular customer, and provides instruction to an operator as to whether to service the customer location by picking up waste from the receptacle. When the operator services the customer location, sensors (e.g., optical sensors) located at the waste opening of the service vehicle identify that waste has been collected and, in some embodiments, identify the type of waste collected. In some embodiments, the sensor at the waste opening may include a camera that records or captures a picture of the waste collected from the customer location. The images and video collected by the camera are transmitted to the processor. The processor may further send data associated with the waste collection to a base station, which notifies the waste service provider and customer associated with the customer location that waste has been collected.

### Systems for Waste Management with Service Confirmation

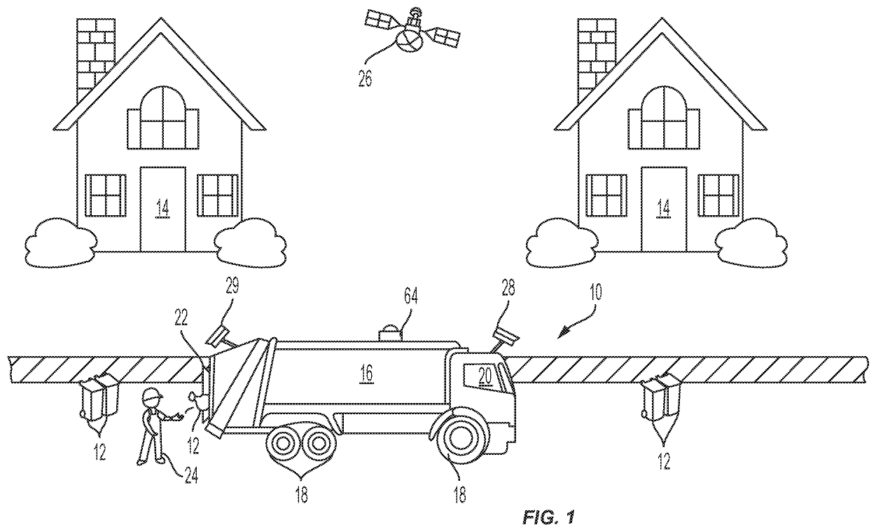

FIG. 1 illustrates an exemplary waste service vehicle 10 that is configured to service one or more receptacles 12 set out at a customer location 14. The service may include, for example, the removal of waste materials from inside of receptacle 12, the removal of receptacle 12, and/or the placement of new or additional receptacles 12 at a particular customer location.

Service vehicle 10 may take many different forms. In the example shown in FIG. 1, service vehicle 10 is a manual-type, rear-loading service vehicle. For example, service vehicle 10 may include a hopper 16 supported by a plurality of wheels 18, and a cab 20 located forward of hopper 16. An opening 22 may be formed at a rear or side of hopper 16, and an operator 24 may be tasked with placing and/or dumping receptacles 12 into hopper 16 via opening 22. In another example, service vehicle 10 may be equipped with a lifting device that is controlled to automatically lift and/or tilt receptacles 12, for example from the rear, side, and/or front of service vehicle 10. In yet another example, service vehicle 10 may be a flatbed or roll-off type of service vehicle, wherein the lifting device is powered to load receptacle 12 into hopper 16 for transportation of receptacle 12 away from the environment. Other configurations may also be possible, and the disclosed concepts are not limited to a type of service vehicle 10.

As each service vehicle 10 moves about its environment, one or more satellites 26 or other tracking systems may communicate with an onboard locator 64 to monitor the movements of service vehicle 10 and associated changes made to the environment (e.g., pickup, dumping, placement, etc.). Locator 64 may be configured to generate signals indicative of a geographical position, orientation, and/or bearing of service vehicle 10 relative to a local reference point, a coordinate system associated with the environment, a coordinate system associated with Earth, or any other type of 2-D or 3-D coordinate system. For example, locator 64 may embody an electronic receiver configured to communicate with satellites 26, or a local radio or laser transmitting/receiving system used to determine a relative geographical location of itself. Locator 64 may receive and analyze high-frequency, low-power radio, or laser signals from multiple locations to triangulate a relative 3-D geographical position, orientation, and/or bearing. Based on the signals generated by locator 64 and based on known kinematics of service vehicle 10, a position, orientation, bearing, travel speed, and/or acceleration of service vehicle 10 may be determined. This information may then be used to update the locations and conditions of service vehicle(s) 10 and/or receptacles 12 in an electronic map or database of the environment.

In some embodiments, the electronic map or database of the environment is maintained at a base station. The service vehicles communicate wirelessly to the base station through one or more of Satellite, WiFi, RF, 3g, UHB, or other wireless technology. In some embodiments, processing of the data collected by the sensors on the service vehicles occurs at the base station, and the results are sent back to the service vehicle. In other embodiments, the base station provides processing in addition to the processing of data that occurs at the processor located at the service vehicle.

The base station tracks the locations and scheduled routes of the one or more service vehicles and may alter the routes provided to the service vehicles. For example, where a service vehicle has been rendered unable to complete the service vehicle's scheduled route, the base station identifies the outstanding customer service locations to be serviced, and alters the routes of the other service vehicles to include the outstanding customer service locations. The base station may also receive customer requests for waste pickup outside of a customer's scheduled waste pickup time. The base station determines which service vehicle to fulfill the customer's request based on information collected from the service vehicles. For example, the base station takes into account the location of the service vehicle, the location associated with the customer's request, the route of the service vehicle, the capacity of the service vehicle to receive more waste, and other information to determine which service vehicle to fulfill the customer's request.

The base station also stores information related to the service vehicle's route and the amount of waste collected along the route. For example, if a particular customer location is found to produce more waste on average than another customer location, the base station may recommend alternative routes so as to prevent an individual service vehicle from being overfilled with waste. By tracking the average amount of waste associated with individual customer locations and assigning routes to the service vehicles accordingly, the base station distributes the waste collected across multiple service vehicles. The base station can also take into account days where more waste is generally generated, such as around a holiday. For example, around a holiday such as Christmas, where a large amount of additional waste is generated, the base station may adjust the routes of the service vehicles to accommodate for the large amount of additional waste.

One or more optical sensors 28 (e.g., cameras or other optical sensors) may be used in some applications to capture images of receptacles 12 (and/or waste associated with receptacles 12). For example, one or more forward-facing optical sensors may be mounted onboard service vehicle 10 and oriented to capture images of the environment relative to the travel direction of service vehicle 10 including images depicting one or more receptacles 12 at locations in front of and/or to the side of vehicle 10, while one or more hopper sensors 29 may be located at opening 22 to capture images of receptacles 12 during servicing. In the depicted embodiment, one hopper sensor is located at or near an upper edge of opening 22 and angled inward to capture images of opening 22 during tilting and/or dumping of receptacles 12 (e.g., by operator 24 or automated lifting device). In another embodiment, hopper sensor(s) 29 may alternatively, or additionally, be located at one or both lateral sides of opening 22. For example, an automated side-loading vehicle 10 may include a single hopper sensor 29 at only one side of opening 22, while a manual rear-loading vehicle 10 may include two hopper sensors such as an optical sensor located at opposing sides of opening 22. Each of optical sensor 28 and hopper sensor(s) 29 may be configured to generate signals associated with the captured images. Sensors such as LiDAR and infrared sensors may also be included at 29, as well as one or more cameras.

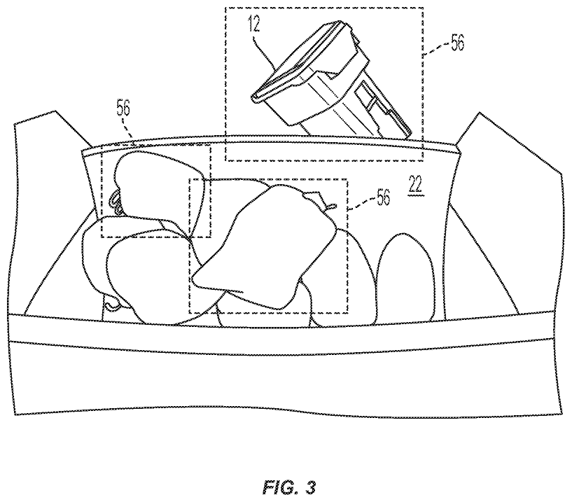

An exemplary image captured by hopper sensor 29 is shown in FIG. 3. The signals generated by optical sensor 28 and hopper sensor(s) 29 may be transmitted to other onboard and/or offboard components via hard wires or wirelessly, and based on one or more established or proprietary communication protocols (e.g. NFC, Bluetooth, Wi-Fi (e.g., 802.11), cellular signals (e.g., NB-IoT, GSM, CDMA, LTE, or LTE-M), satellite, etc.).

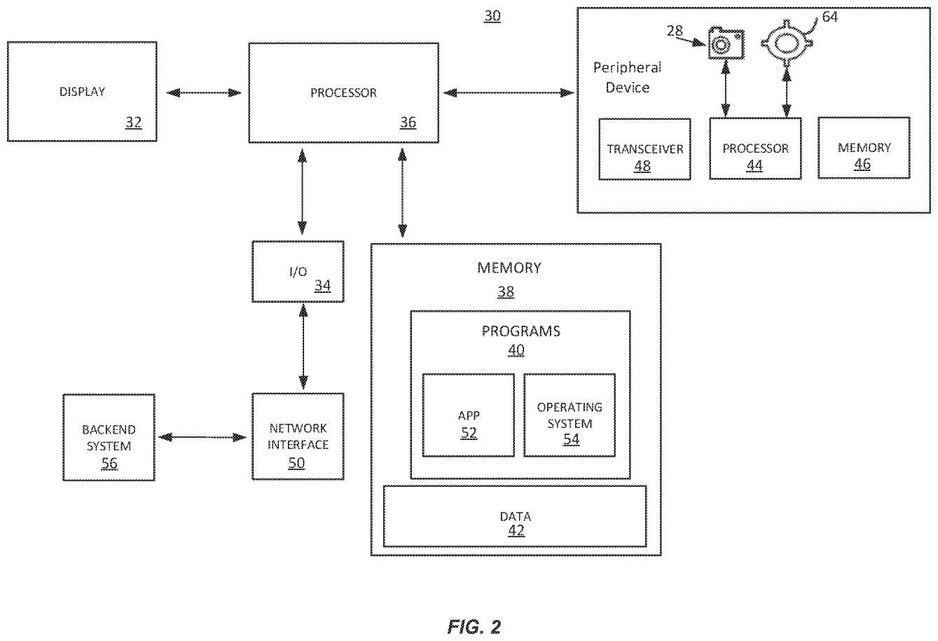

Locator 64, optical sensor 28, and hopper sensor(s) 29 may be considered peripheral devices of a control system 30, which is shown in more detail in FIG. 2. As shown in FIG. 2, control system 30 may additionally include a display 32, any number of input/output (“I/O”) devices 34, one or more single- or multi-core processors 36, and a memory 38 having stored thereon one or more programs 40 and data 42.

Display 32 may include a liquid crystal display (LCD), a light emitting diode (LED) screen, an organic light emitting diode (OLED) screen, and/or another known display device. Display 32 may be used for the rendering of video signals (e.g., images captured by optical sensor(s) 28), graphics, data (e.g., location data from locator 64), and text under the control of processor 36.

I/O devices 34 may be configured to send and receive information. I/O devices 34 may include, for example, a keyboard, buttons, switches, a touchscreen panel (e.g., a panel integrated with display 32), a microphone, and/or a speaker (e.g., a speaker integrated with display 32). I/O devices 34 may also include one or more communication modules (not shown) for sending information to, and/or receiving information from, other onboard and/or offboard components of control system 30.

The I/O devices 34 may be further configured to send and receive information to a backend system 56 through a network interface 50. The network interface 50 may be used to connect the system to the base station, offboard components, one or more servers, and backend systems. For example, the network interface may be used to receive information from the base station such as a new recommended route. The network interface may also be used to send data collected by sensors associated with the service vehicles to store in a database or on a server.

The peripheral devices (e.g., optical sensor(s) 28, hopper sensor(s) 29, locator 64, artificial lighting, and other devices) may be standalone devices or devices that are embedded within control system 30. As shown in the example embodiment of FIG. 2, peripheral devices may themselves include one or more processors 44, a memory 46, and a transceiver 48. The peripheral device can include additional or fewer components, depending on a type of control system 30. The control system 30 may also include a transceiver for use in transmitting information to, and/or receiving information from onboard and/or offboard components of control system 30 (e.g. peripheral device(s), a user device, and/or back office).

Processor 44 associated with one or more of the peripheral devices (e.g., with optical sensor(s) 28, hopper sensor(s) 29, and/or locator 64) may be configured with virtual processing technologies, and use logic to simultaneously execute and control any number of operations. Processor 44 may be configured to implement virtual machine or other known technologies to execute, control, run, manipulate, and store any number of software modules, applications, programs, etc. In some embodiments, processor 44 can be configured to execute instructions to receive commands from processor 36 associated with video, audio, and/or location data capture and/or transmission. For example, processor 44 may be configured to receive images from optical sensor(s) 28 and preprocess the images (e.g., resize the images, normalize the images, convert the images, etc.) before directing the images to processor 36. In some embodiments, processor 44 may be omitted and the functions described above alternatively performed directly by processor 36, if desired.

Memory 46 can be a volatile or non-volatile, magnetic, semiconductor, tape, optical, removable, non-removable, or other type of storage device or tangible (i.e., non-transitory) computer-readable medium that stores computer executable code, such as firmware. The medium may cause processor 44 to perform one or more functions associated with data capture, data processing, data storage, data transmitting via transceiver 48, and data receiving via transceiver 48. In some embodiments, memory 46 can include one or more buffers for temporarily storing data received from the peripherals, before transmitting the data to processor 36.

Transceiver 48 may include a wired or wireless communication module capable of sending data to and receiving data from one or more components in system 30 via a local network and/or another direct communication link. In some embodiments, transceiver 48 can receive data from processor 36, including instructions for processor 44 to activate one or more of the peripherals and capture video/audio/location (e.g., GPS) data and for processor 44 to transmit the data via transceiver 48. In response to the received instructions, transceiver 48 can packetize and transmit the video/audio/location data to processor 36. Similarly, transceiver 48 may be configured to packetize and transmit data directly to one or more offboard components (e.g. to one or more user devices, and/or a back office) based on one or more established or proprietary communication protocols (e.g. NFC, Bluetooth, Wi-Fi (e.g., 802.11), cellular signals (e.g., NB-IoT, GSM, CDMA, LTE, or LTE-M), satellite, etc.).

Processor 36 can include one or more processing devices configured to perform functions of the disclosed methods. Each processing device can constitute a single-core device or a multi-core device executing parallel processes simultaneously. For example, processor 36 can be a single-core processor configured with virtual processing technologies. In certain embodiments, processor 36 uses logical processors to simultaneously execute and control multiple processes. Processor 36 can implement virtual machine technologies, artificial intelligence (i.e., AI), machine learning, and/or other known technologies to provide the ability to execute, control, run, manipulate, store, etc. multiple software processes, applications, programs, etc. In another embodiment, processor 36 includes a multiple-core processor arrangement (e.g., dual, quad core, etc.) configured to provide parallel processing functionalities to allow control system 30 to execute multiple processes simultaneously. As discussed in further detail below, processor 36 is specially configured with one or more applications and/or algorithms for performing method steps and functions of the disclosed embodiments. For example, processor 36 (and more generally, control system 30) can be configured with hardware and/or software components that enable processor 36 to receive real-time sensor feed, record video, record location, receive control instructions regarding anticipated and/or actual waste services, analyze recorded video and/or data, and/or selectively transmit the recorded information and/or analyzed data and control instructions. It is appreciated that other types of processor arrangements could be implemented that provide for the capabilities disclosed herein.

Memory 38 may include a volatile or non-volatile, magnetic, semiconductor, tape, optical, removable, non-removable, or other type of storage device or tangible and/or non-transitory computer-readable medium, which stores one or more executable programs 40 (e.g., a waste management app 52) and data 42. Data 42 can include, for example, information that is personal to customers receiving the waste services (e.g., account information, addresses, service frequencies, etc.), settings, and preferences.

In some embodiments, programs 40 also include an operating system 54 that performs known functions when executed by processor 36. By way of example, the operating system may include Microsoft Windows®, Unix®, Linux®, Apple® operating systems, mobile device type operating systems such as iOS or Android, Personal Digital Assistant (PDA) type operating systems, such as Microsoft CE®, or another type of operating system. Control system 30 may also include communication software that, when executed by processor 36, provides communications with an external network, such as web browser software, tablet, or smart handheld device networking software, etc. via a communication module (not shown).

Waste management app 52 may cause control system 30 to perform processes related to generating, transmitting, storing, and receiving data in association with participants of a waste service agreement. For example, waste management app 52 may be able to configure control system 30 to perform operations including: displaying a graphical user interface (GUI) for receiving disposal instructions and related information from the operator of control system 30; capturing photographic and/or video data from one or more peripheral devices associated with servicing of receptacles 12; capturing location data associated with receptacles 12 and/or a location at which servicing occurs; receiving instructions via I/O devices 34 and/or the user interface regarding timing of and/or cost for servicing; processing the control instructions; sending the video data, the location data, and the instructions to another location (to a back office and/or a customer); receiving data and instructions from the other locations; and arranging for electronic payment in association with confirmed servicing.

Exemplary processes performed by control system 30 are illustrated in FIGS. 3, 4 and 5. These processes will be explained in more detail in the following section to further illustrate the disclosed concepts.

### Methods for Waste Management with Service Confirmation

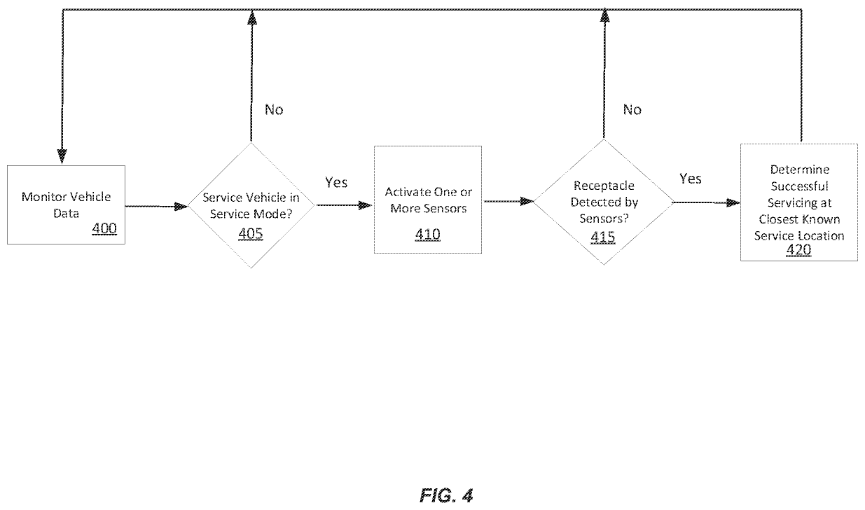

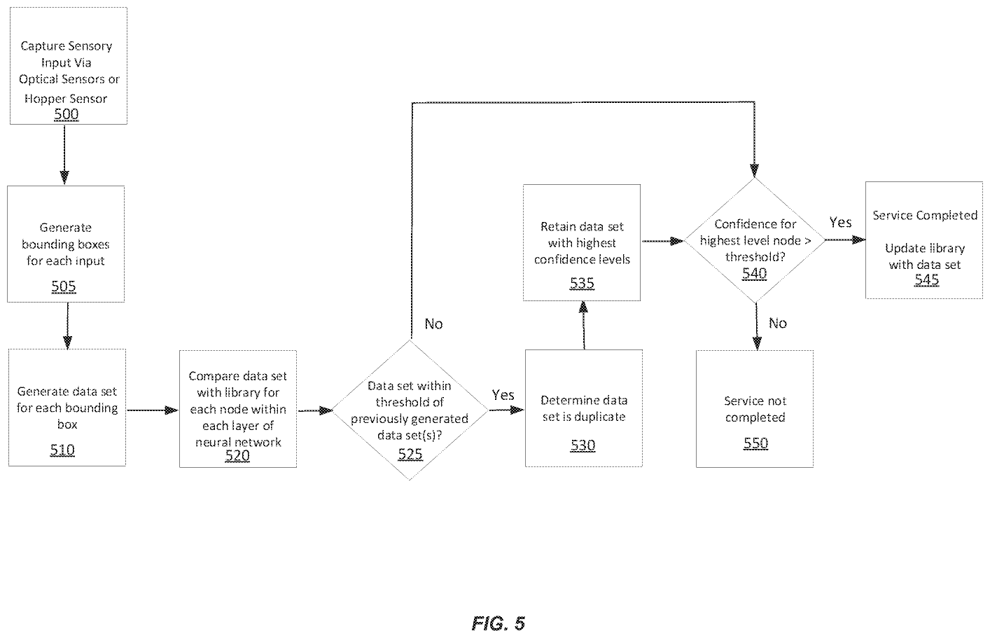

FIGS. 4 and 5 are flowcharts showing illustrative methods of operation of a system for waste management with service confirmation. In some examples, some of the steps in flow charts of FIGS. 4 and 5 may be implemented in program code executed by a processor, for example, the processor in a general purpose computer, mobile device, or server. In some examples, these steps may be implemented by a group of processors. In some examples the steps shown in FIGS. 4 and 5 may be performed in a different order or one or more steps may be skipped. Alternatively, in some examples, additional steps not shown in FIGS. 4 and 5 may be performed.

As shown in FIG. 4, operation of system 30 may begin by with position, orientation, bearing, speed and/or acceleration monitoring of service vehicle 10 and tracking of associated data (Step 400). This monitoring may be automatically triggered any time that vehicle 10 is active (e.g., any time that vehicle 10 is turned on, moving, moving in a particular direction, etc.). Alternatively, this monitoring may be triggered manually or configured to always be active. During monitoring, locator 64 may generate signals indicative of the location, orientation, bearing, speed and/or acceleration of vehicle 10 and direct the signals to processor 36 for analysis.

The system then determines whether the vehicle is in service mode (Step 405). Any number of conditions may need to be satisfied for processor 36 to conclude that vehicle 10 is operating in a service mode. In one embodiment, determination of a travel speed of vehicle 10 alone may be sufficient for processor 36 to make this conclusion. In another embodiment, processor 36 may need to determine a travel speed of vehicle 10 and detect a presence of receptacle 12 within a proximity of vehicle 10. In further embodiments the vehicle 10 be located within a geo-fenced area along the vehicle's route, and the geo-fenced area may be used to determine the vehicle 10 is in service mode. In yet another embodiment, each of travel speed, bearing, receptacle detection, and geo-fence location may be used to determine that the vehicle is in service mode.

For example, processor 36 may compare the signals generated by locator 64 with one or more thresholds associated with a service mode of operation. When the comparison is satisfied, processor 36 may determine that vehicle 10 is likely operating within the service mode. Otherwise, processor 36 may conclude that vehicle 10 is being operated within another mode (e.g., a transit mode, a yard mode, a landfill mode, etc.) or is non-operational.

In the example of FIG. 4, the threshold used for comparison by processor 36 may be associated with a maximum speed (e.g., 5-15 mph or about 10 mph) at which receptacle servicing should be performed. For instance, processor 36 may determine, based on a time comparison of the location signals, a velocity of vehicle 10 and compare the velocity to the maximum speed. While locator 64 is described above as being used to detect a travel speed of vehicle 10, another dedicated speed sensor could alternatively be used. When the comparison indicates that a travel speed of vehicle 10 is greater than the maximum speed, processor 36 may conclude that vehicle 10 is not in the service mode of operation and control may return to Step 400. However, when the comparison indicates that a travel speed of vehicle 10 is less than the maximum speed, processor 36 may conclude that vehicle 10 could be servicing receptacles and the service vehicle may be determined to be in service mode. In other examples, the determination may be made based on multiple factors not limited to a comparison of speed, and may include whether a receptacle has been detected.

Processor 36 may also determine if receptacle 12 has been detected. For example the processor may make this determination based in part on data collected from a sensor, such as an image collected by optical sensor(s) 28 or other sensors. Other sensors may be used, including infrared, and radar such as LIDAR. This determination and/or identification may be made via artificial intelligence (AI) using one or more neural networks. It is contemplated, however, that the determination of Step 405 could be made in another manner, if desired. For example, if other sensors on the service vehicle identify a receptacle, or if an operator provides indication that the vehicle is in service mode, the vehicle may be determined to be in service mode. In the disclosed example, when a receptacle 12 is not detected and/or identified at Step 405, processor 36 may determine that, regardless of the travel speed of vehicle 10, vehicle 10 is not operating in the service mode. Under this condition, control may return to Step 400.

It should be noted that, although AI and neural networks have been described as an exemplary way to confirm that servicing of a customer receptacle 12 has been completed (e.g., by recognizing receptacle 12 at opening 22 of hopper 16 during a time when vehicle 10 is moving at a servicing mode travel speed in a service direction), other methods may alternatively be employed. For example, any way to automatically detect the presence of receptacle 12 at opening 22 during operation in the service mode may be implemented. This may include, for example, automatically scanning a bar code or other indicia on receptacle 12, detecting proximity of a sensor affixed to receptacle 12, etc. Once servicing at a known location has been confirmed, processor 36 may generate an electronic output.

The electronic output may inform a user of system 30 that service at the known location has been confirmed. The electronic output may include, for example, a showing of related information (e.g., the known location, a map of the environment, a status identifier, etc.) on display 32. The electronic output may also or alternatively include a logging of information within memory 38 and/or transmission of the information to an offboard location (e.g., to the back office, to a customer location, etc.). The electronic output may also or alternatively include electronic billing of the customer for the confirmed service, adjusting of future service events (e.g., scheduling), etc.

When a receptacle 12 is detected and/or identified at Step 405, processor 36 may conclude that vehicle 10 is operating in the service mode and responsively activate sensors such as the hopper sensor(s) 29, or other sensors such as a radar sensor or infrared sensor (Step 410). By activating the sensors only after successful completion of Step 405, life of the sensors may be extended, and an amount of data generated and/or analyzed may be reduced. In some embodiments, the sensors could be activated manually, continuously active, or activated in another manner.

In some embodiments, a simple detection of receptacle 12 may be enough to advance control from Step 405 to Step 410. However, in other embodiments, receptacle 12 may need to be detected within a threshold distance of a known service location (e.g., a location at which a subscribing customer lives or operates a business) and/or detected while vehicle 10 is traveling in a particular direction in order to advance control from Step 405 to Step 410. This determination may be made by comparing location data generated by locator 64 with known service locations and one or more predetermined threshold values. When a detected receptacle 12 is not within the threshold value of a known service location, vehicle 10 is not traveling in a required service direction (e.g., for a given side of the road to be serviced with a given rear- or side-loading configuration), regardless of the travel speed of vehicle 10, control may return to Step 400. The determination of whether vehicle 10 is in service mode may be made based on location information from the locator or other device such as a GPS. When the vehicle is determined to be near a known service location, the vehicle may determine to be in service mode. In other examples, the vehicle may include a WiFi positioning system to identify that the vehicle is near a known service area, by identifying the location of the vehicle based on information from nearby routers or other WiFi enabled devices.

in further embodiments the vehicle 10 may be within a predetermined geo-fence along the vehicle's route, and the geo-fenced area may be relied upon to determine that the vehicle 10 should enter service mode. The determination may be made by comparing location data generated by locator 64 to location data associated with the geo-fence. When the vehicle is within the geo-fence, the vehicle may determine to be in service mode.

Other examples may use NFC technology to determine that the vehicle is in service mode. For example, vehicle 10 may include sensors to detect waste receptacles with attached or embedded NFC tags.

After activation of the sensors at Step 410, processor 36 may determine if receptacle 12 has been detected within an image or other information generated by the sensors or hopper sensor 29 (Step 420). This determination may also be made via AI using one or more neural networks (e.g., the same or different neural networks used at Step 405). In the disclosed example, when a receptacle 12 is not detected at Step 415, processor 36 may determine that servicing of the receptacle 12 has not been completed. Under this condition, control may return to Step 400.

However, when a receptacle 12 is detected at Step 415, processor 36 may conclude that service at the known location has been completed (Step 420). This information may be stored for later use and/or transmitted offboard vehicle 10. Control may then return to Step 400.

In some embodiments different detection requirements may be used at Step 415 to conclude successful servicing at Step 420. For example, in an automated loading configuration of vehicle 10, any detection of receptacle 12 may be sufficient to conclude servicing because of the known reliability of automated loading. Further, in some embodiments, one or more filters (e.g., detected size filters) may be applied. Further, in some embodiments, only detection of a loading receptacle 12 and not of a background receptacle 12 triggers classification as a successful service event. In one embodiment, a manual rear-loading configuration of vehicle 10, receptacle 12 may need to be detected as having crossed an edge boundary into hopper 16 or otherwise breaking the plane of opening 22 before confirmation of servicing may be made. In this same example, multiple detections of receptacle 12 may need to be made, such that receptacle 12 can be tracked from a particular side of vehicle 10. This may help to accurately associate servicing with a particular side of the road on which vehicle 10 is traveling.

Multiple methods may be used to link the confirmed service with a particular known location. In the example of a side-loading vehicle configuration, the signals from locator 64 may be used together with a bearing of vehicle 10 to link the service confirmation to a known location at the same side of the road. This may be accurate, as only one side (e.g., the right side in the U.S.) of a given road may be serviced by vehicle 10. However, in the example of a rear-loading vehicle configuration where receptacles 12 may be manually taken from either side of the road and dumped into hopper 16, optical sensor(s) 28 may be utilized to look for additional information (e.g., house numbers, mailbox numbers, geographic features, etc.) that can be linked to the service confirmation. Alternatively, motion tracking of identified receptacles 12 may be used to determine from which side of the road the receptacles 12 have been taken.

When the service cannot be linked with a known location automatically, a set of options representing the locations being serviced may be presented to a driver of the vehicle. The set of options may be generated based on a list of nearby customers narrowed by information gathered by the sensors. For example, if a sensor were to determine that a known location has already been serviced, the serviced location would not be included in the set of options. In other examples, if a sensor were unable to determine the location within a tolerance of 200 feet, the set of options would only include locations within 200 feet of the vehicle. In further examples, where optical sensors are used to determine location by identifying street signs, or mail box numbers, where portions of the signs or mail box numbers are obscured or otherwise unreadable, the portion of the signs or mail box number that is readable may be used to narrow the list of options. For example, if multiple locations require service on a street, and the optical sensor identifies a number on a mailbox of a location requiring service, the list of options presented to the driver would only present a list of locations on the street including the identified number in the address. The driver then selects a location from the options to link the service confirmation.

FIG. 5 illustrates an exemplary process that may be completed at Step(s) 405 and/or 415 to detect and/or identify receptacle 12 within an image captured by the optical sensor and/or hopper sensor(s). As shown in FIG. 5, the first step may include capturing of input via the corresponding optical sensor(s) 28 or hopper sensor 29 (Step 500). As described above, this capturing may occur in multiple ways. For example, optical sensor(s) 28 may generate one or more images continuously and processor 36 may receive, capture, record, retain, analyze or otherwise use the images only when the associated conditions (e.g., conditions of Step 405) have been satisfied. Alternatively, optical sensor(s) 28 may generate the image(s) used by processor 36 only when the associated conditions have been satisfied and processor 36 may always receive, capture, record, retain, analyze or otherwise use the images. Other strategies may alternatively or additionally be employed, if desired. An exemplary image captured by optical sensor(s) 28 at Step 500 is illustrated in FIG. 3.

The image(s) captured at Step 500 may thereafter be analyzed by processor 36. For example, processor 36 may generate one or more bounding boxes within each captured image (Step 505). Any method known in the art for generating bounding boxes may be implemented at Step 505. In one example, the bounding box(es) may be generated via a clustering algorithm, which creates a histogram of pixels containing similar parameter data (e.g., similar hues, tints, tones, shades, textures, brightness, reflectivity, luminescence, etc.). Each grouping of adjacent pixels within the histogram that contains similar data may be considered an independent object, and a virtual box 56 (referring to FIG. 3) may be placed around each object and assigned one or more coordinates (e.g., a center coordinate, corner coordinates, boundary line coordinates, etc.) based on its position relative to all of the captured pixels within a parameterized range of sensor output and/or based on its position relative to known coordinates of hopper 16.

A data set for each bounding box may then be generated (Step 510). The data set may include cumulative (e.g., mean, median, etc.) values for one or more (e.g., for each) of the pixel parameters discussed above, as well as collective parameters for the entire object (e.g., shape, size, location, parameter gradients, aspect ratio, etc.).

Processor 36 may utilize AI to determine if the data set is associated with a service event having been completed. For example, processor 36 may compare via one or more neural networks each data set to any number of predetermined conditions stored within a library of memory 38 and known to be associated with completion of the service event (Step 520). The neural network(s) may include any number of different layers operating in parallel or series, each layer having any number of different nodes. Each layer of a given neural network may search for a different feature, parameter, and/or combination of features and parameters of a target object (e.g., of receptacle 12, of waste inside of or falling from receptacle, etc.) that is expected to be observed during the service event. Each node within each layer may analyze a different pixel of the data set.

When a particular pixel at a particular node within a particular layer of a given neural network has the parameter that the given layer is searching for (e.g., within a designated range), then that pixel may be weighted higher for that parameter (i.e., given a higher correlation of the pixel being associated with the target object(s)). When the particular pixel at the particular node within the given layer does not have the parameter that the layer is searching for (e.g., the pixel has a parameter value outside of the designated range), then that pixel may be weighted lower for that parameter (i.e., given a lower correlation of the pixel grouping being associated with the target object(s)). It should be noted that, in some embodiments, different layers of the network(s) may give different weightings to the confidence values.

Depending on the correlation value assigned at a particular node within a given layer, analysis of the pixel may progress through the network(s) along different paths to different nodes in other layers. In this way, each pixel may pass through the network(s) from an input side to an output side and accumulate an overall confidence value during the progression. The confidence values of all pixels within a given grouping (e.g., the grouping associated with a given bounding box 56) may then be accumulated (e.g., summed).

In some instances, multiple images may be captured at Step 500 that are associated with a same location, a same receptacle 12, and/or a same service event. In order to inhibit duplication of efforts and/or logging of duplicate information, filtering of the data sets generated at Step 510 may be selectively implemented. For example, processor 36 may be configured to compare each newly generated data set with other previously generated data sets (e.g., data sets generated within a threshold period of time, such as within a previous 60 seconds) to determine an amount of similarity between the data sets (Step 525). In some embodiments, when values of a new data set are within threshold amounts of values of a data set generated within the last minute, processor 36 may conclude that the new data set is a duplicate (Step 530) and retain only the set having the higher confidence value(s) (Step 535).

Processor 36 may then compare the confidence value(s) of the retained data set(s) to one or more threshold values associated with the target object (Step 540). When the overall confidence value for a grouping of pixels within a common bounding box 56 is greater than the threshold value associated with the target object (i.e., that receptacle 12 has been identified at the known service location when the travel speed of vehicle 10 in a service direction places vehicle 10 within the service mode of operation—Step 540: YES), processor 36 may determine that service at the known location is being or has been successfully completed (Step 545). The library of features and parameters associated with receptacle 12 (and/or the waste within or falling from receptacle 12) that is stored within memory 38 may then be updated with the data set. Control may then return to Step 500.

Returning to Step 540, when the overall confidence value for a grouping of pixels from a common bounding box 56 is less than the threshold value associated with the target object (i.e., that receptacle 12 has not been identified—Step 540: NO), processor 36 may determine that service is not being or has not been completed (Step 550). Control may then return to Step 500.

The disclosed system may provide tools that can be used to confirm performance of waste services and/or to account for waste services that were not performed. By detecting when a waste service is occurring or has occurred and whether the service has been provided in accordance with assigned parameters, the disclosed system may allow for efficient management of associated duties (e.g., billing, scheduling, payments, etc.). In addition, the disclosed system, based on confirmation that a particular waste service cannot be performed, may be able to selectively implement a remedial action that ensures customer satisfaction. All of these things may ultimately result in greater profitability for the service provider.

It will be apparent to those skilled in the art that various modifications and variations can be made to the disclosed system. Other examples will be apparent to those skilled in the art from consideration of the specification and practice of the disclosed system. It is intended that the specification and examples be considered as illustrative only, with a true scope being indicated by the following claims and their equivalents.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A system for managing waste services performed by a service vehicle, comprising:
a locator mounted to the service vehicle and configured to generate a location signal;
a sensor mounted at a waste opening of the service vehicle and configured to generate a receptacle signal; and
a processor in communication with the locator and the sensor and configured to:
determine, based on the location signal, operation of the service vehicle in a service mode;
detect, based on the receptacle signal, existence of a waste receptacle at the waste opening; and
generate an electronic output based on the detection.

2. The system of claim 1, wherein the processor determines operation of the service vehicle in the service mode when the location signal indicates a travel speed of the service vehicle being less than a threshold speed.

3. The system of claim 1, wherein the sensor is a camera configured to generate an image of the waste receptacle at the waste opening.

4. The system of claim 3, wherein the processor is programmed to implement a neural network to automatically identify the waste receptacle within the image.

5. The system of claim 4, wherein:
the processor is configured to generate at least one bounding box around at least one object in the image; and
the processor is configured to implement the neural network to recognize the waste receptacle within the at least one bounding box.

6. The system of claim 1, wherein the electronic output is associated with confirmation of a service event being performed at a closest known customer location.

7. The system of claim 6, further including a display, wherein the electronic output is a showing of the confirmation on the display.

8. A method for managing waste services performed by a service vehicle, the method comprising:
detecting a location of the service vehicle;
determining, based on the location, operation of the service vehicle in a service mode;
detecting existence of a waste receptacle at a waste opening of the service vehicle; and
generating an electronic output based on the detection.

9. The method of claim 8, wherein determining operation of the service vehicle in the service mode includes determining, based on a change in the location of the service vehicle over time, a travel speed of the service vehicle being less than a threshold speed.

10. The method of claim 8, wherein detecting existence of a waste receptacle at the waste opening includes capturing an image of the waste receptacle at the waste opening and identifying the waste receptacle in the image.

11. The method of claim 10, wherein identifying the waste receptacle in the image includes implementing a neural network to compare properties of pixels in the image with properties of a target waste receptacle that are stored in memory.

12. The method of claim 10, further including generating at least one bounding box around at least one object in the image, wherein identifying the waste receptacle in the image includes identifying the waste receptacle within the at least one bounding box.

13. The method of claim 8, wherein responsively generating the electronic output includes generating electronic confirmation of a service event being performed at a closest known customer location.

14. The method of claim 13, wherein generating electronic confirmation of a service event being performed includes outputting the electronic confirmation on a display.

15. A non-transitory computer readable medium comprising program code, which when executed by one or more processors, is configured to cause the one or more processors to:
detect a location of a service vehicle;
determine, based on the location, operation of the service vehicle in a service mode;
detect existence of a waste receptacle at a waste opening of the service vehicle; and
responsively generating an electronic output based on the detection.

16. The non-transitory computer readable medium of claim 15, wherein determining operation of the service vehicle in the service mode includes determining, based on a change in the location of the service vehicle over time, a travel speed of the service vehicle being less than a threshold speed.

17. The non-transitory computer readable medium of claim 15, wherein detecting existence of a waste receptacle at the waste opening includes capturing an image of the waste receptacle at the waste opening and identifying the waste receptacle in the image.

18. The non-transitory computer readable medium of claim 17, wherein identifying the waste receptacle in the image includes implementing a neural network to compare properties of pixels in the image with properties of a target waste receptacle that are stored in memory.

19. The non-transitory computer readable medium of claim 17, further including generating at least one bounding box around at least one object in the image, wherein identifying the waste receptacle in the image includes identifying the waste receptacle within the at least one bounding box.

20. The non-transitory computer readable medium of claim 15, wherein responsively generating the electronic output includes showing an electronic confirmation of a service event being performed at a closest known customer location on a display.
